(19) United States
(12) Patent Application Publication
(10) Pub. No.: US 2005/0094930 A1
(43) Pub. Date: May 5, 2005

(54) Wavelength selective switching and/or routing system

(76) Inventor: Thomas W. Stone, Hellertown, PA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/700,828

(22) Filed: Nov. 4, 2003

(51) Int. Cl. G02B 6/26; G02B 6/34

(52) U.S. Cl. 385/16; 385/37

(57) ABSTRACT

Switching and/or routing devices use separating diffraction gratings or AWG, a selectable switching and routing sub-sytem system, and recombining diffraction gratings or AWG to overcomes problems associated with insertion loss, size and compactness, switch isolation, switching speed, which may be present in current optical switching systems. The selectable switching and routing sub-system can include a switchable grating based sub-system or a switchable mirror based sub-sytem.

### CROSS-REFERENCE TO RELATED APPLICATIONS

This application is a continuation-in-part of co-pending U.S. patent application Ser. No. 09/943,847 filed on Aug. 31, 2001, which is incorporated by reference herein.

### FIELD OF THE INVENTION

The present invention relates generally to interconnection and switching systems, and, more particularly, to optical switching /routing systems which incorporate the use of selectable switching and routing components.

### BACKGROUND OF THE INVENTION

With the advent of substantial new uses for high bandwidth digital systems, particularly Wavelength Division Multiplexing (WDM) and Dense Wavelength Division Multiplexing (DWDM) systems, and analog electro-optic systems, there exists a greater need to effectively control the routing and switching capability of electro-optic or optical signals from among many possible paths. This is especially true in digital computing systems where signals must be routed among processors; in analog systems such as phased array radar; and in the switching of high bandwidth optical carriers in communication systems, including long haul and metro communication systems. However, it should be realized that these are just several of numerous electro-optic systems which require the use of an optical switching or routing mechanism.

In many current and future systems light beams are modulated in a digital and/or analog fashion and used as “optical carriers” of information. There are many reasons why light beams or optical carriers are preferred in these applications. For example, as the data rate required of such channels increases, the high optical frequencies provide a tremendous improvement in available bandwidth over conventional electrical channels such as formed by wires and coaxial cables. In addition, the energy required to drive and carry high bandwidth signals can be reduced at optical frequencies. Further, optical channels, even those propagating in free space (without waveguides such as optical fibers) can be packed closely and even intersect in space with greatly reduced crosstalk between channels. Finally, operations that are difficult to perform in the lower (e.g., radio) frequencies such as time shifting for phased array applications can often be performed more efficiently and compactly using optical carriers.

A common problem encountered in many applications in which high data rate information is modulated on optical carrier beams is the switching of the optical carriers from among an array of channels. This problem is further complicated in the case of WDM and DWDM systems where many discrete channels are separated by small increments in wavelength. These differing optical channels may represent, for example, routes to different processors, receiver locations, or antenna element modules, or multiplexed signal propagating through a fiber. One approach to accomplish this switching is to extract the information from the optical carrier, use conventional electronic switches, and then re-modulate the optical carrier in the desired channel. However from noise, space, and cost perspectives it is more sometimes desirable to directly switch the route of the optical carrier directly from the input channel to the desired channel.

U.S. Pat. No. 5,771,320 discloses a free space optical switching and routing system utilizing a switchable grating based approach together with novel noise suppression techniques. This family of devices provides for an optical switching and routing system that is useful for interconnecting any of an input array's optical channels to any of an output array's optical channels. The invention disclosed in U.S. Pat. No. 5,771,320 has several distinct advantages including compactness, a reduction in insertion loss and the number of required switching devices and control signals.

U.S. Pat. No. 6,072,923 discloses an optical switching and routing system utilizing high efficiency switched mirrors. The switched mirrors can function, for example, by diffraction (diffractive mirrors) or reflection (reflective mirrors) and have the benefit of a lack of angular dispersion, where the steered direction does not strongly depend on wavelength.

The optical switching and routing system of U.S. Pat. Nos. 5,771,320 and 6,072,923 utilize a series of optical input signals, which form a one dimensional input array of m optical channels. These optical input signals may either be directly input to the switching and routing system, or they may originate as electrical input signals that are converted in a conventional manner into optical signals prior to input. Accordingly, this input array may include an array of optical fibers, semiconductor lasers (e.g., Vertical Cavity Surface Emitting Lasers or VCSELs), or free space beams.

While the optical switching and routing system of U.S. Pat. Nos. 5,771,320 and 6,072,923 exhibit reduced crosstalk and low loss, the applications in which these optical switching and routing systems are utilized possess an ever-increasing need for compactness, reduced insertion loss and increased isolation. There is a need for reduced insertion loss, decreased size and “foot-print”, increased switch isolation, and higher switching speed.

It is an object of this invention to provide an optical switching and/or routing system that provides for a compact geometry.

It is also an object of this invention to provide a compact wavelength selectable switching and/or routing system.

It is another object of this invention to provide an optical switching and/or routing system that provides for a low loss one-to-one optical interconnection from a set of input channels to a set of output channels.

### SUMMARY OF THE INVENTION

The present invention overcomes problems associated with insertion loss, size and compactness, switch isolation, switching speed, and wavelength selectivity which may be present in current optical switching systems. The present invention includes switching and/or routing devices that use a separating sub-system (such as, but not limited to, separating diffraction gratings or array wavequide gratings, AWGs), a selectable switching and routing sub-system, and recombining sub-system (such as, but not limited to, diffraction gratings or AWGs).

During operation of the system of the present invention, optical radiation from an input beam port is separated into distinct input channels utilizing the separating sub-system. Embodiments of the separating sub-system include, but are not limited to, a pair of separating fixed gratings or array waveguide gratings (AWGs). Desired ones of the separated distinct input channels are selected, switched and/or routed by operating the selectable switching and routing sub-system. The selected channels from the distinct input channels are propagated through the selectable switching and routing sub-system. As a result of the propagation, the selected channels from the distinct input channels are directed to desired distinct output channels. The desired distinct output channels are recombined utilizing the recombining sub-system. Embodiments of the recombining sub-sytem include, but are not limited to, AWGs or a pair of fixed gratings.

The selectable switching and routing sub-system can include, but is not limited to, a switchable grating based sub-system or a switchable mirror based sub-system such as those defined in U.S. Pat. No. 5,771,320, issued to T. W. Stone on Jun. 23, 1998, and U.S. Pat. No. 6,072,923, issued to T. W. Stone on Jun. 6, 2000, both of which are hereby incorporated by reference.

For a better understanding of the present invention, together with other and further objects, reference is made to the following description taken in conjunction with the accompanying drawings, and its scope will be pointed out in the appended claims.

### BRIEF DESCRIPTION OF THE DRAWINGS

FIG. 1a is a schematic representation of one embodiment of the switching and/or routing system of this invention;

FIG. 1b is a schematic representation of another embodiment of the switching and/or routing system of this invention;

FIG. 1c is a schematic representation of a conventional component (AWG) utilized in the embodiment of FIG. 1b;

FIG. 2a is a schematic representation of an embodiment of the switching system of this invention incorporating diffraction gratings therein;

FIG. 2b is a schematic representation another embodiment of the switching and/or routing system of this invention incorporating array waveguide gratings (AWGs) therein;

FIG. 3 is a schematic representation of an embodiment of the switching and routing sub-system of U.S. Pat. No. 5,771,320;

FIG. 4a is a schematic representation of an embodiment of a planar optical switching and routing sub-sytem.

FIG. 4b is a schematic representation of another embodiment of a planar optical switching and routing sub-system;

FIG. 5 is a schematic representation of the switching and/or routing system of this invention incorporating electrically switchable diffraction gratings therein and having M input channels and N output channels;

FIG. 6a is a schematic representation of yet another embodiment of a planar optical switching and routing sub-system;

FIG. 6b is a schematic representation of an embodiment of an array of planar optical switching and routing sub-systems;

FIG. 7 is a schematic representation of the planar optical switching and routing sub-system incorporating switchable volume holographic mirrors therein;

FIG. 8 is a schematic representation of another embodiment of a planar optical switching and routing sub-system incorporating switchable gratings; and,

FIG. 9 is a schematic representation of another embodiment of a planar optical switching and routing sub-system incorporating switchable gratings and a mirror array.

### DETAILED DESCRIPTION OF THE PREFERRED EMBODIMENTS

The present invention provides an optical switching and/or routing system utilizing a separating sub-system, a switching and routing sub-system, and recombining sub-system. This invention provides an optical switch and/or router that is useful for, but not limited thereto, interconnecting any of an input array's optical channels with any of an output array's optical channels. The incorporation of the separating and recombining sub-systems in the present invention adds even further to the advantages over past optical switching techniques. More specifically, these advantages include, but are not limited to, a reduction in insertion loss, an increase in switching speed, and improvements in crosstalk suppression, and compactness.

In order to better understand the present invention described below, it should be noted that certain terms used in the description of the invention have interchangeable usage. For example, the term “optical” refers not only to optical components, but also to electro-optical components and the terms “optical beam” and “electromagnetic radiation beam” may be used interchangeably.

Furthermore, terms such as “beam paths” and “channels” may also be interchanged, in certain instances, based upon their usage as recognized in the art. The term “free space” when used with the present invention means that the optical channels are freely propagating without imposed lateral confinement.

In addition, identical components may be referred to with identical reference numerals within the specification and drawings for simplifying an understanding of the various components of this invention.

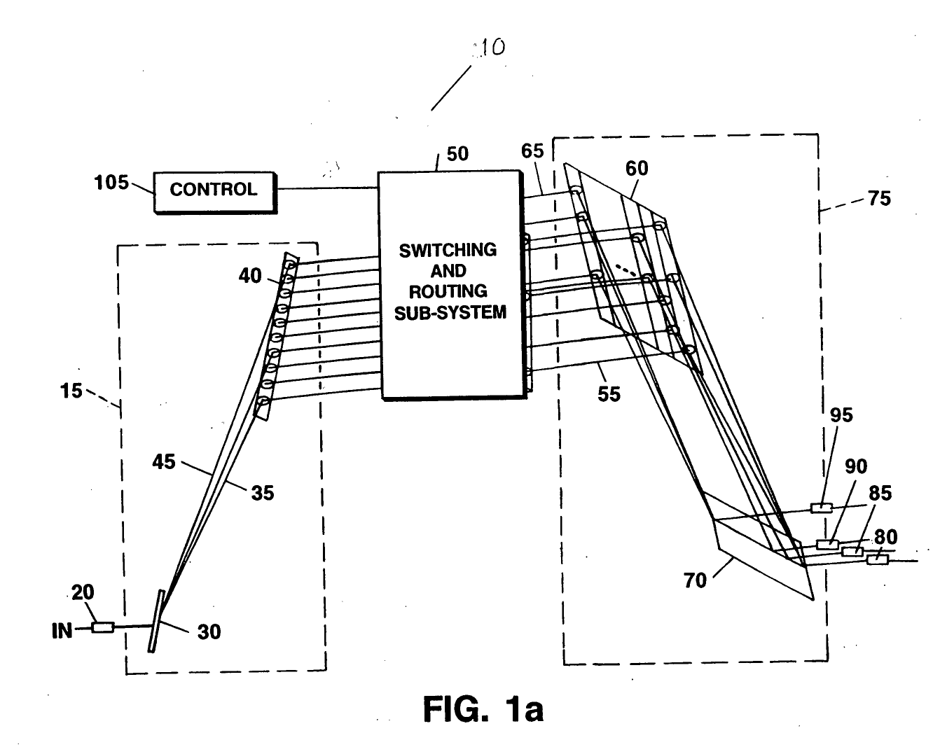

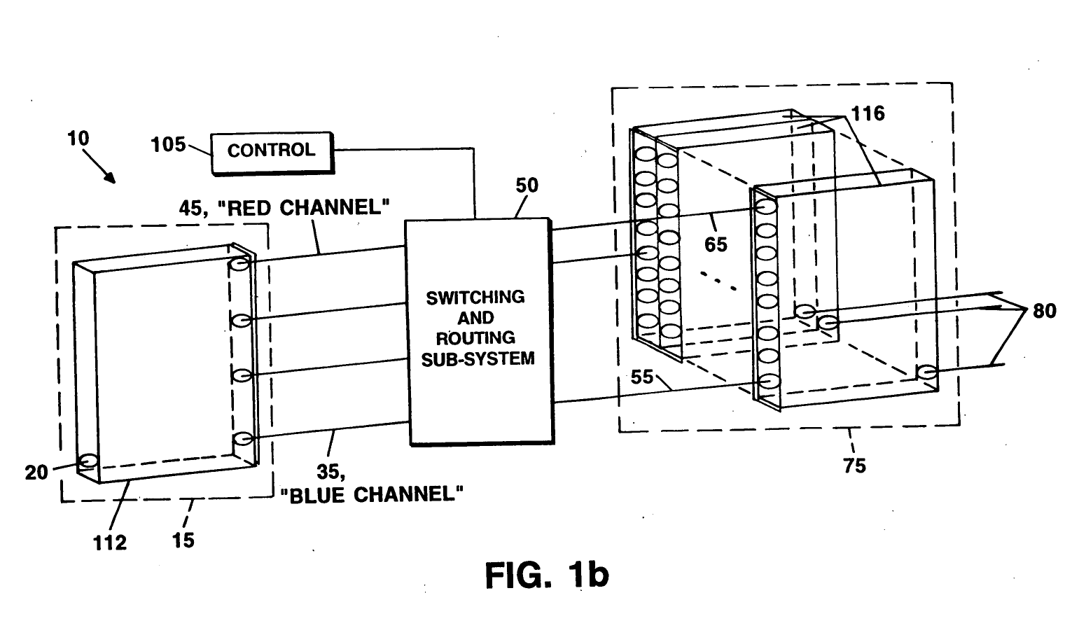

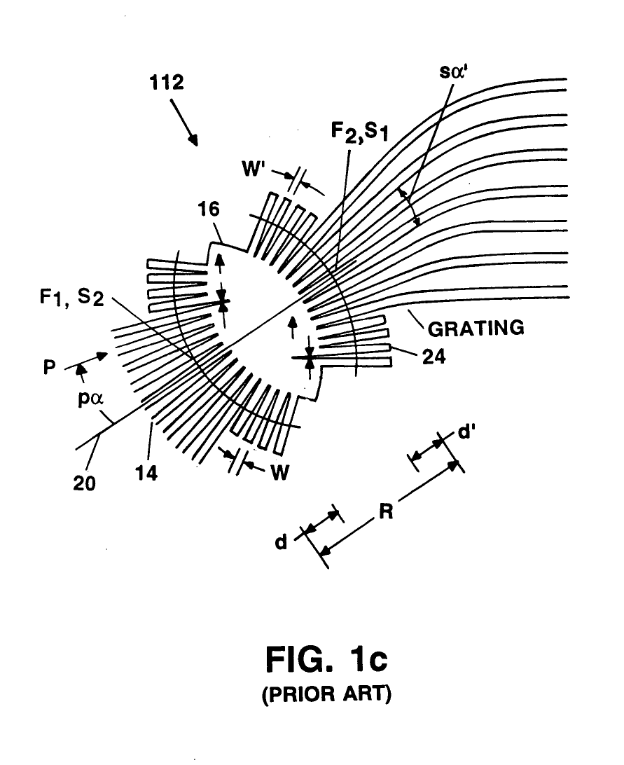

Reference is now made to FIG. 1a that illustrates an embodiment of a switching and/or routing system 10 of this invention. Fixed gratings 30 and 40 constitute an embodiment of an optical separating sub-system 15. Fixed grating 60 and fixed grating 70 constitute an embodiment of an optical recombining sub-system 75. Optical sub-systems 15 and 75, selectable switching and routing sub-system 50, and control means 105 comprise the switching and/or routing system 10.

During operation, input beam/port 20 provides input optical radiation 25 that impinges upon fixed grating 30. Fixed grating 30 separates the input optical radiation 25 into distinct input channels 35 through 45. (The number of input optical channels is different for different embodiments. Only two are labeled in FIG. 1a.) Fixed grating 40 redirects the distinct input channels 35 through 45. The distinct input channels 35 through 45 are the inputs to the selectable switching and routing sub-system 50. The selectable switching and routing sub-system 50 includes one or more pixellated switchable components, where each pixellated, switchable component has a number of pixels, each of the pixels having a controllable state. Control means 105 control the state of each of the pixels. In one embodiment, the control means 105 enable the selecting of desired distinct output channels 55 through 65. In another embodiment, the control means 105 determine the mapping of the input channels 35 through 45 into the desired output channels 55 through 65. (The number of output optical channels is different for different embodiments. Only two are labeled in FIG. 1a.) Fixed gratings 60 and 70 redirect and recombine output channels 55 through 65 to output beam-ports 80 through 95. (The number of output beam-ports is different for different embodiments. Only four are labeled in FIG. 1.).

FIG. 1 b depicts an embodiment of a switching and/or routing system 10 of this invention utilizing AWGs 112, 116 in the separating sub-system 15 and the recombining sub-sytem 75. Input beam/port 20, in this embodiment, can be an optical waveguide or free space beam coupled to the AWG 112. Output beam/ports 80, in this embodiment, can be optical waveguides or free space beams coupled from the AWGs 116. Optical sub-systems 15 and 75, selectable switching and routing sub-system 50, and control means 105 comprise the switching and/or routing system 10.

FIG. 1c depicts a conventional AWG. An AWG 112 is an interconnection apparatus having a plurality of closely spaced input waveguides 14 communicating with the input of a star coupler 16. The output of the star coupler 16 communicates with an optical grating comprising a series of optical waveguides 24, each of the waveguides differing in length with respect to its nearest neighbor by a predetermined fixed amount.

Referring again to FIG. 1b, during operation, input beam/port 20 provides input optical radiation to the AWG 112. AWG 112 separates the input optical radiation into distinct input channels 35 through 45 each with a characteristic center wavelength. (The number of input optical channels is different for different embodiments. Only two are labeled in FIG. 1b.) The distinct input channels 35 through 45 are the inputs to the selectable switching and routing sub-sytem 50. Control means 105 control the state of each of the pixels. In one embodiment, the control means 105 enable the selecting (transmission or deflection/absorption) of desired distinct output channels 55 through 65. In another embodiment, the control means 105 determine the mapping of the input channels 35 through 45 into the desired output channels 55 through 65. (The number of output optical channels is different for different embodiments. Only two are labeled in FIG. 1b.) AWGs 116 recombine output channels 55 through 65 to output beam-ports 80. Each AWG 112, 116 may include a microlens or microlens array in order to transform the output of the AWGs into free space beams or to couple the free space beams back into the AWGs. The microlens or microlens array can include refractive or diffractive optical components. Anamorphic optics may be used optionally to transform the waveguide outputs of the AWGs into circular beams. (The number of output beam-ports is different for different embodiments.)

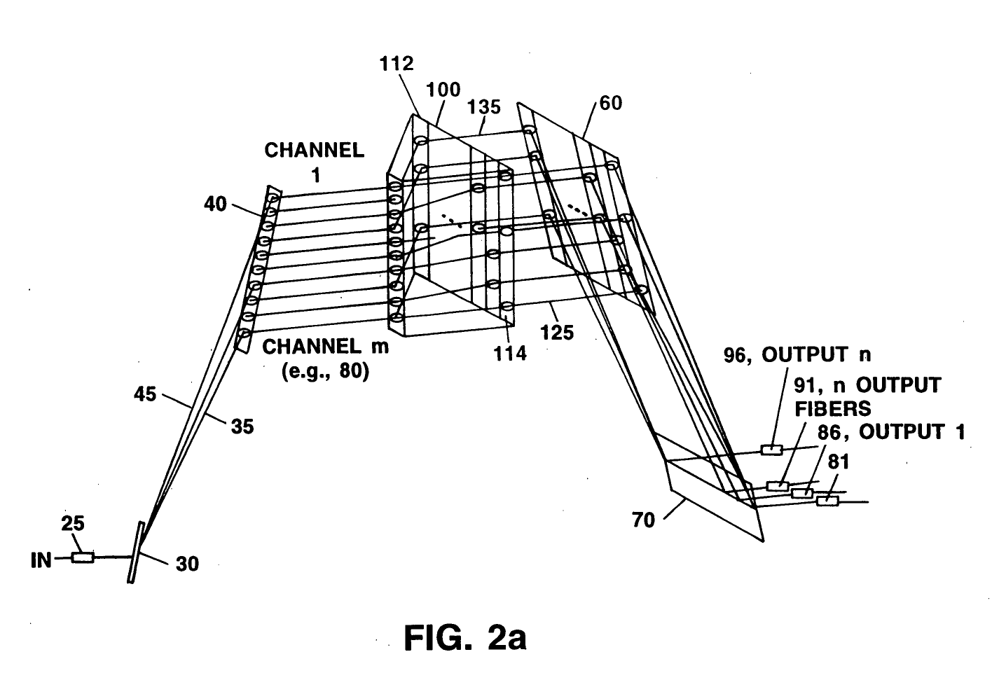

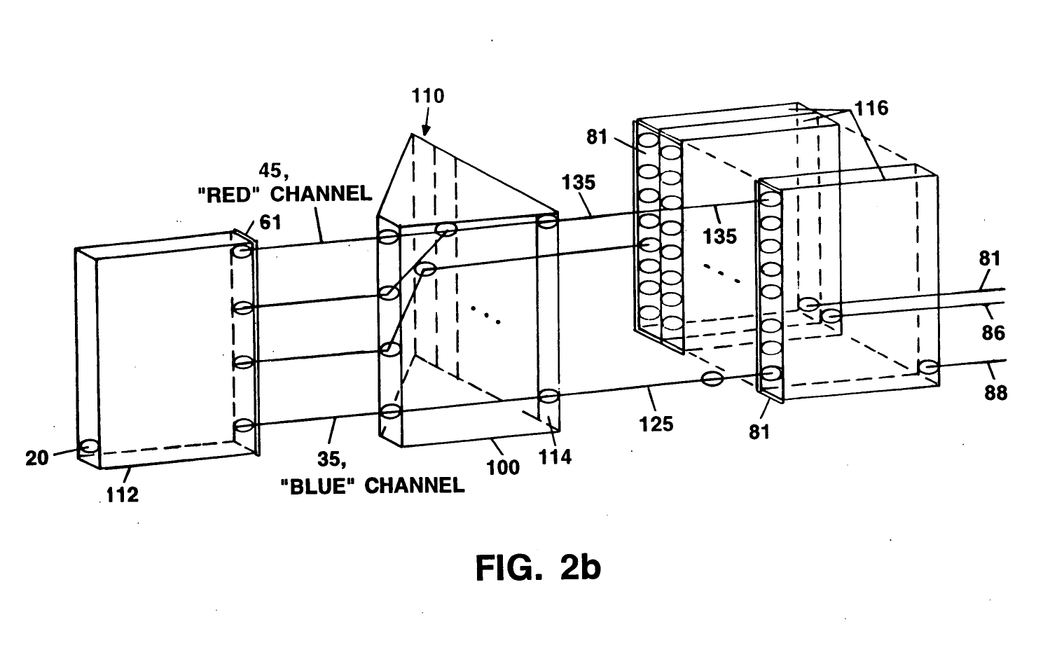

FIG. 2a depicts a switching and/or routing system 10 of this invention incorporating electrically switchable diffraction gratings, such as those disclosed in U.S. Pat. No. 5,771,320, as an embodiment of the selectable switching and routing sub-system 50 of FIG. 1a. The switching and routing sub-system described in U.S. Pat. No. 5,771,320 is a “free space” switching/routing sub-system. This “free space” sub-system is in contrast with other “guided-wave” systems wherein the optical channels are confined or guided in structures such as optical fiber waveguides and planar optical waveguides. In order to facilitate rugged construction and minimize losses associated with surface reflections, these free space systems will typically include clear dielectric spacers (for example, glass, plastic) that separate the switched gratings and other components. In one embodiment of the switching and routing sub-system described in U.S. Pat. No. 5,771,320, the switchable diffraction gratings are volume holographic gratings.

Referring to FIG. 2a, the input radiation 25 is separated into m spectral input channels 35 through 45 using a twin grating disperser, comprised of gratings 30 and 40, in which the gratings are typically parallel to each other and of the same spatial frequency. (Control means are not shown in FIGS. 2a and 2b. However, the control means operate as in the same manner as in FIG. 1b.) The spectrally resolved input channels are then passed through an array of m 1×N switches 100 as shown. Each of the m input channels 35 through 45 is independently routed to any of N output columns 112 through 114. Output beams 125 through 135 emerge from the switching and routing sub-system 100 and are incident on the recombining sub-system comprised of grating pair 60 and 70. The final grating pair recombiner, comprised of grating pair 60 and 70, is similar to the input grating pair 30 and 40. In the embodiment shown in FIG. 2a, the gratings in the final pair 60 and 70 is wider than the gratings in the input grating pair 30 and 40. In the embodiment 3 shown in FIG. 2a, the gratings in the final pair 60 and 70 recombine N output columns from the from the switching and routing sub-system 100. The recombining, redirecting grating pair 60 and 70 recombines any wavelength channels present in a given column into an array of N multiplexed output channels as shown in FIG. 2a. Each of m wavelength channels in the input can be independently routed to any of N output ports, 81, 86, 91, 96.

FIG. 2b depicts an embodiment of the switching and/or routing system 10 of this invention incorporating electrically switchable diffractive gratings, such as those disclosed in U.S. Pat. No. 5,771,320, as an embodiment of the selectable switching and routing sub-sytem 50 of FIG. 1b. Referring to FIG. 2b, the input 20 is separated into its m spectral input channels 35 through 45 using an AWG 112 and a microlens array 61. The spectrally resolved input channels are then passed through an array of m 1×N switches 100 as shown. Each of the m input channels 35 through 45 is independently routed to any of N output columns 110 through 114. Output beams 125 through 135 emerge from the switching and routing sub-system 100 and are incident on the (recombining sub-system) final AWG combiner comprised of AWGs 116. Each of m wavelength channels in the input can be independently routed to any of N output ports, 81, 86, 88. In the configuration of FIG. 2b, a microlens array 61 is used to transform the output of the AWG 112 into free space beams and another microlens array 81 can be used to couple the free space beams back into waveguides of the recombining AWGs 1-16. Anamorphic optics may be used optionally to transform the waveguide outputs of the AWGs into circular beams to enhance coupling efficiency into the waveguides or to enhance coupling efficiency between the waveguides and optical fibers.

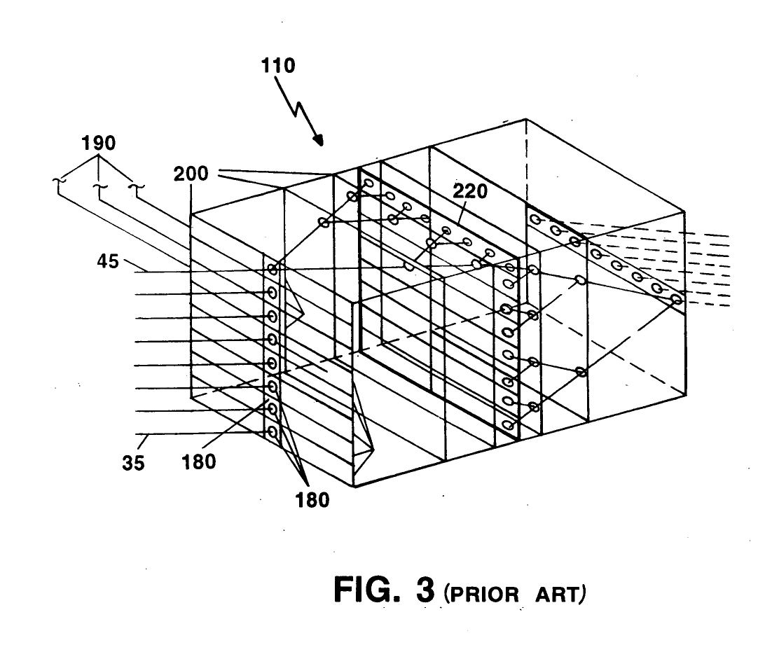

In one embodiment, the array of m 1×N switches 100 shown in FIGS. 2a, 2b is the front half of the M×N cross connect 110 (FIG. 3) as described in U.S. Pat. No. 5,771,320, shown in FIG. 3. Referring to FIG. 3, input channels 35 through 45 form a vertical input array 180. Following the input array of channels 180 is a first router assembly 110 that includes a cascade of n switchable diffractive gratings 200A, 200B, 200C, etc. (also referred to as gratings 200), which are separated by distances varying by powers of 2 and which are each separately switchable in segments 170. Each segment of the segments 170 corresponds to one of the m input channels 35 through 45 in the input array 180. These m grating segments 170 of each of gratings 200 are separately controlled with electrical signals 190. Electrical signals 190 are one embodiment of the control means 105 of FIG. 1. When a particular grating segment 170 is “on,” the beam incident on that segment is completely switched by diffraction with little loss from the incident beam to a diffracted beam traveling in a new direction. When the grating segment 170 is switched “off” the incident beam is transmitted with little loss and without deviation. These switched gratings therefore steer the incident beam along a selected path as a function of the control signals 190 which turn the various grating segments 170 “on” or “off.”

The array of m 1×N switches 110 of FIG. 3 has very low insertion loss and is compact for the typical dimensions of wavelength selective cross-connects. The array of m 1×N switches 110 of FIG. 3 also has a relatively low manufacturing cost since only a small number of stripe-pixellated gratings need be fabricated for the array (e.g., 3 gratings for an array of 80 1×8 switches).

It should be noted that the implementation of the array of m 1×N switches 110 of FIG. 3 relies upon the ability to switch the path of the beams 35 through 45 (input optical channels) quickly, with little crosstalk and with low loss. Some of the switchable grating technologies that are capable of such high performance switching include polymer dispersed liquid crystal (PDLC) gratings; fillable porous holographic gratings; and ferroelectric liquid crystal polarization rotators in conjunction with polarization sensitive holographic gratings. Some of the switchable grating technologies provide the ability to fan-out a given input to more than one output.

It should also be noted that, although in the above embodiment the gratings are electrically switched, other embodiments are possible. Other possible means for controlling the state of the pixels (switching the gratings) are electrical switching, optical switching, and polarization switching of the gratings. Embodiments utilizing optical switching and polarization switching of the gratings are disclosed in U.S. Pat. No. 5,692,077, issued to T. W. Stone and M. S. Malcuit on Nov. 25, 1997, hereby incorporated by reference.

Although FIGS. 2a, 2b present embodiments of the switching and/or routing sub-system 100 utilizing switchable transmission gratings, other embodiments utilizing switchable mirrors, such as those described in U.S. Pat. No. 6,072,923, as the embodiment of the switching and/or routing system 100 are possible. The switchable mirrors used in U.S. Pat. No. 6,072,923 can be made using various technologies, such as, but not limited to, volume holographic mirrors, multilayer mirrors, deformable mirrors and micro electromechanical mirrors. But the common feature is that the mirrors exhibit a reflectance that is variable and controllable. When in an “off” state, the mirrors are transparent (or, alternatively, displaced out of the path of the incident beam). When in an “on” state, the mirrors are reflective (or, alternatively, displaced into the path of the incident beam).

A significant benefit of using the switched mirror elements described in U.S. Pat. No. 6,072,923 in place of switched transmission gratings is that there is little or no angular dispersion of the optical channel or beam when steered with these mirror elements. Thus multiple wavelengths or broad-spectrum light can be routed, delayed, interconnected, or switched with little or no dispersive angular deviation of the optical carrier. In one of the preferred embodiments of the invention disclosed in U.S. Pat. No. 6,072,923, volume phase holographic switchable mirrors are used to enable switching of the incident energy between the transmitted and reflected directions. Such switchable mirrors may be controlled by electrical switching, optical switching, and polarization switching of the mirrors, in a manner similar to that discussed above for holographic gratings.

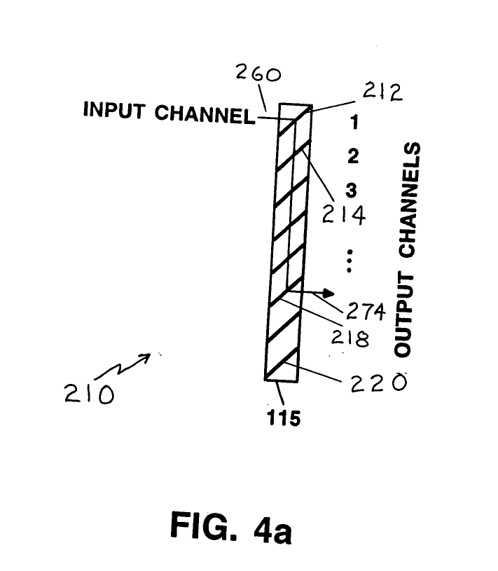

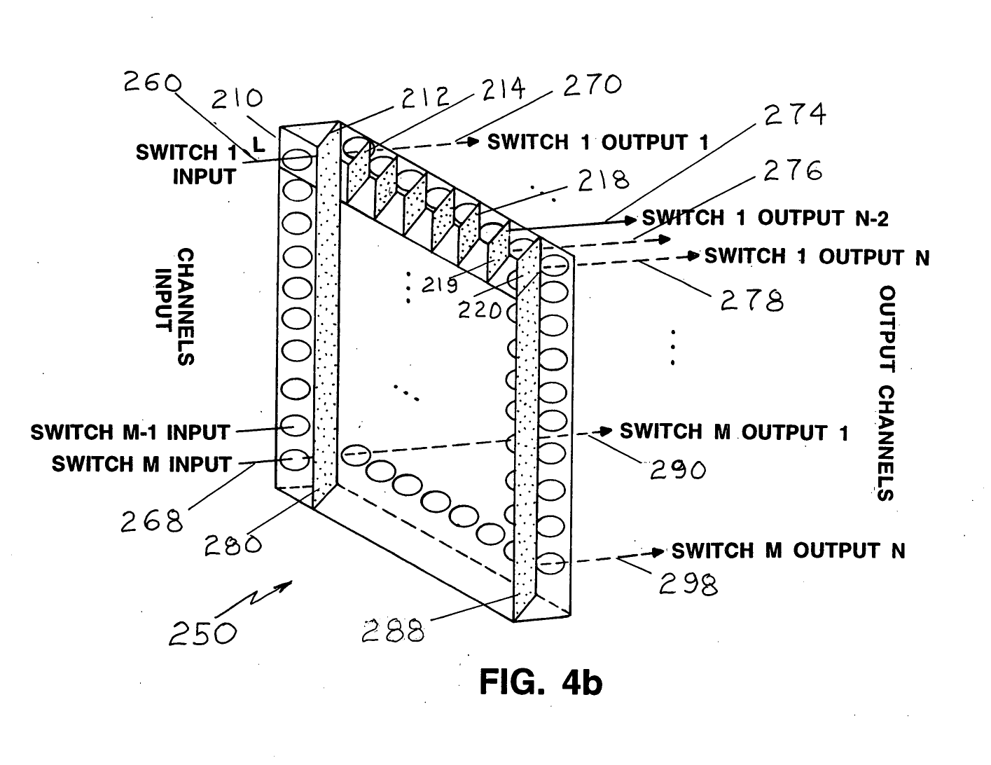

A more compact alternative, related to U.S. patent application Ser. No. 09/943,847 (filed on Aug. 31, 2001), incorporated by reference herein, for the array of m 1×N switches 100 is shown in FIGS. 4a and 4b. System 250 in FIG. 4b is a compact array of M 1×N optical switches. This switching system 250 includes N switchable gratings 212, 214, . . . , 218, . . . 220 that are stripe pixellated in layers 210. A detail of a single (top) layer 210 is illustrated in FIG. 4a.

In the 1×N switching layer 210 shown in FIG. 4a, input beam 260 is incident on the first switchable grating pixel of pixellated grating 212 as shown. Combinations of on and off states of pixels of gratings 212, 214, . . ., 218, . . ., 220 switch or route the input beam to any of N possible outputs. In FIG. 4a, input beam 260 is routed to output channel 274 by setting grating pixels 212 and 218 to “on” (diffracting), and all intermediate grating pixels to off (transparent).

In the operation of the compact array of M 1×N optical switches shown in system 250 of FIG. 4b, M layers of the 1×N switch layer 210 are stacked by pixellating the N gratings 212, 214, . . ., 218, . . ., 220 each into M pixels as shown.

Each of these M×N individually switchable grating pixels are individually controlled (not shown) as in earlier systems described herein. Accordingly input 260 into the top layer 210 of system 250 can be routed to output channel 270 by setting the first pixel 212 to “off”. Setting the first pixel 212 to “on” permits routing to output channels 274, 276, 278 respectively by setting the last grating pixels 218, 219, 220 on, respectively. Similarly, for the Mth switch layer, input beam 268 can be routed to output channel 290 by setting the grating pixel 280 to “off”; or to output channel 298 by setting the grating pixels 280 and 288 to “on” (with the intervening pixels set to “off”).

The transmission-grating version is shown, and an analogous switched holographic mirror version, having the advantages described above, is also apparent from the disclosure in U.S. patent application Ser. No. 09/943,847. The input and output interfaces (not shown) for the array of m 1×N switches 115 shown in FIG. 4b are similar to those disclosed in U.S. Pat. Nos. 5,692,077 and 5,771,320.

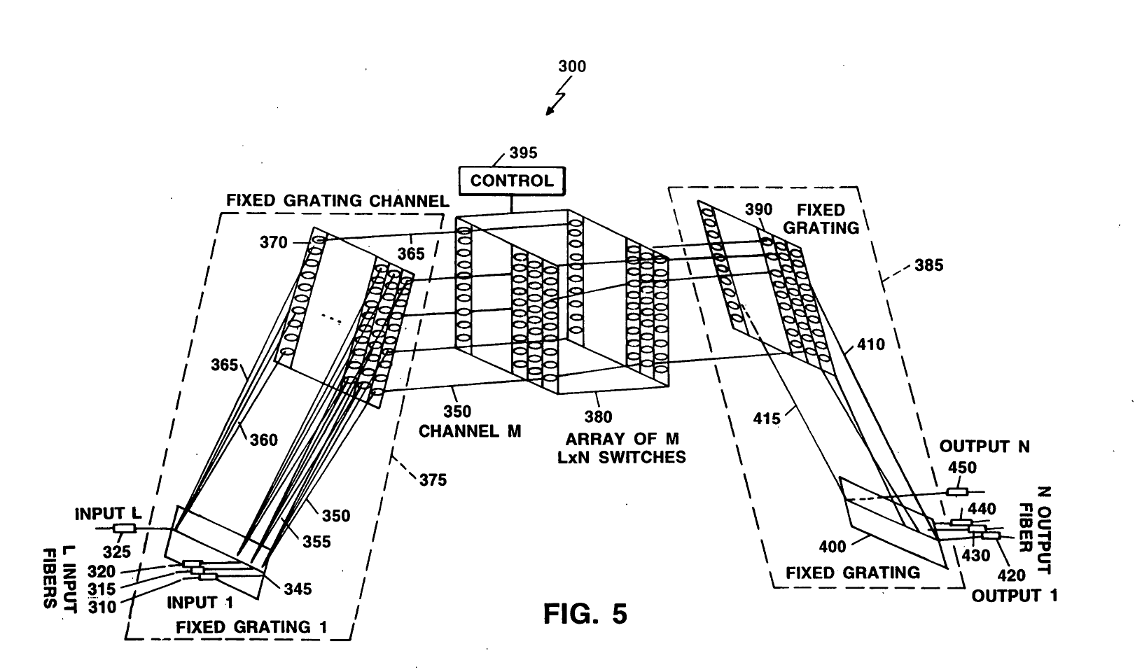

A still further embodiment of the present invention is the L×N wavelength selectable switching and/or routing system 300 shown in FIG. 5. In the embodiment shown in FIG. 5, both the input and output grating pairs are wide as compared to the embodiment shown in FIG. 2a, which has narrow input and wide output gratings. Depicted in FIG. 5 are L input beam/ports, labeled 310 trough 325. Fixed gratings 345 and 370 constitute an optical separating sub-system 375. Fixed grating 390 and fixed grating 400 constitute an optical recombining sub-system 385. Also depicted in FIG. 5 are N output beam ports, labeled 420, 430, 440 through 450. Optical sub-systems 375 and 385, selectable switching and routing sub-system 380, and control means 395 comprise the switching and/or routing system 300. System 300 allows for an array of L multiplexed inputs, such as WDM optical fibers.

During operation, input beam/ports 310 through 325 provide input optical radiation beams 330 through 340 that impinge upon fixed grating 345. Fixed grating 345 separates the input optical radiation beams 330 through 340 into L distinct sets of input channels, 350 through 355 in set one and channels 360 through 365 in the Lₜₕ set. (The number of input optical channels per beam/port and the number of input beam/ports are different for different embodiments. Only four sets of input optical channels and two channels per set are labeled in FIG. 5.) Fixed grating 370 redirects the distinct input channels in each set, 350 through 355 in set one and channels 360 through 365 in the Lₜₕ set. The distinct input channels, 350 through 355 in set one and channels 360 through 365 in the Lₜₕ set, are the inputs to the selectable switching and routing sub-system 380. The selectable switching and routing sub-system 380 includes one or more pixellated switchable components, where each pixellated, switchable component has a number of pixels, each of the pixels having a controllable state. In this embodiment, the selectable switching and routing sub-system 380 includes an array of M L×N switches, which provides for the general wavelength selective L×N cross connect function. Control means 395 control the state of each of the pixels. In one embodiment, control means 395 enable the selecting of the N distinct output channels, labeled 410 through 415. (The number of output optical channels is different for different embodiments. Only two are labeled in FIG. 5.) Fixed gratings 390 and 400 redirect and recombine output channels 410 through 415 to the N output beam-ports, labeled 420 through 450. (The number of output beam-ports is different for different embodiments. Only four are labeled in FIG. 5.) In another embodiment, control means 395 determine the mapping of the input channels 350 through 365 into the desired output channels 410 through 415. In this embodiment, any wavelength component in any of the input ports 310 trough 325 may be directed to any of the output ports 420 through 450.

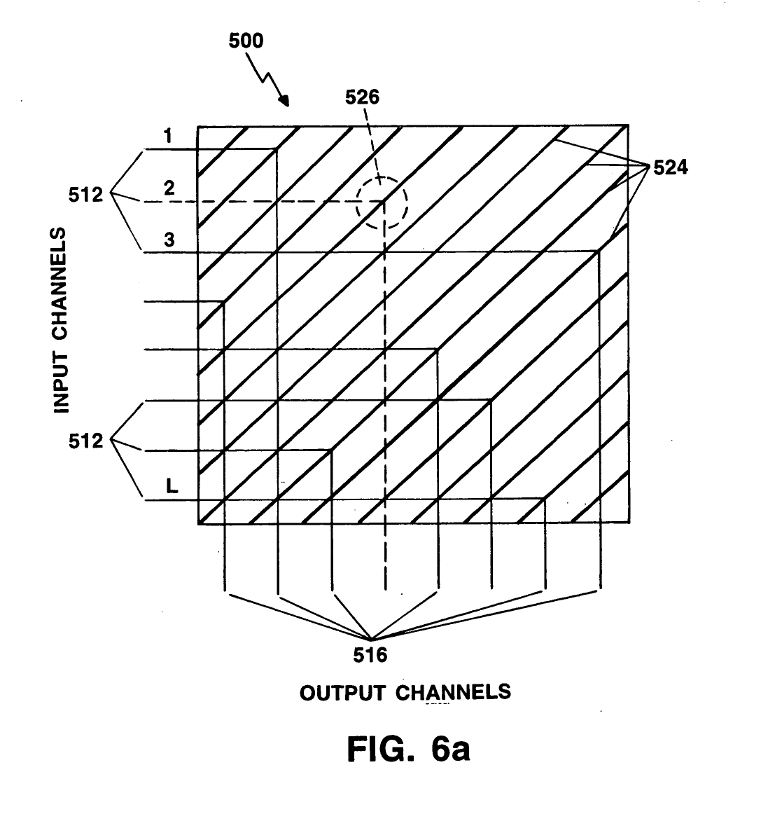

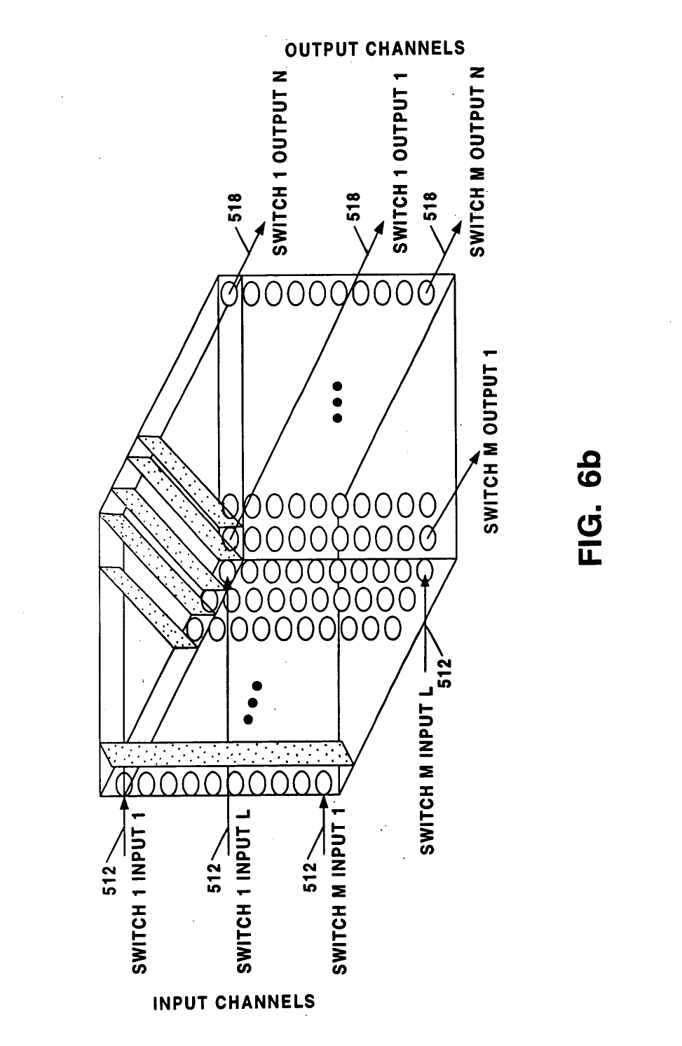

Any channel in any of the L input beam/ports, 310 through 325, can be routed to any of the N output beam/ports, 420 through 450. Many different technologies can be used for the array of M L×N switches 380. Embodiments based on switchable gratings are desirable due to their low insertion loss and high speed. One embodiment of a switch array is an array of planar cross connects 500, described in U.S. patent application Ser. No. 09/943,847 and shown in FIGS. 6a and 6b. The switch 500 of FIG. 6a is a single layer of a stack, shown in cross-section from above. The M L×N device 550, shown in FIG. 6b, can be fabricated by extending the L+N−1 gratings of system 500 and further pixellating them in M individually controllable layers. This M L×N device 550 could be inserted in the configuration of FIG. 5 and the resulting configuration would then be similar to that shown in FIG. 5 but deviated through 90 degrees at the switch 500. The orientation of the recombining system 385 of FIG. 5 for the embodiment of the system 300 utilizing switching/routing sub-system 550 instead of switching/routing sub-system 380 is at right angles from that shown in FIG. 5.

During operation of the systems 500 and 550 of FIGS. 6a, 6b, input optical channels (beams) 512 propagate in free space and are incident on an array of diffractive gratings 524 which switch or re-arrange the beams into the array of output beams 518 as shown in FIG. 6. In the N×N crossbar switch embodiment shown in FIG. 6a, 2N−1 diffractive gratings 524 are arranged to perform this switching operation. The diffractive gratings 524 are electrically, optically, or otherwise switchable, so that they may be turned “off” (a state in which the incident beam is undeviated) or “on” (a state in which the incident beam is diffracted to a new direction). In the switching and/or routing sub-system 500 of FIGS. 6a, gratings that are turned “on” diffract the incident beam into a new path that is angularly deviated from the incident path. In the embodiment shown in FIG. 6a, the input beams are angularly deviated by substantially 90 degrees. (It should be noted that embodiments capable of angularly deviating the input beams by angles other than 90 degrees are possible.) Each of the diffractive gratings 524 is pixellated into one or more separately controllable elements or regions 526 that lie on the intersections of the grating and the incident optical channel paths. For example, one of these locally switchable grating regions 526 is shown circled in FIG. 6a. This pixellation can be accomplished, for the case of electrically switched gratings, by lithographically patterning the electrodes over a given grating. When a grating region is switched “on”, the beam(s) incident on the grating is diffracted and propagate toward an output port. If, however, a grating region is switched off, any beams that are incident on that grating region propagate through the grating without being diffracted.

The crossbar switching and/or routing sub-system 500 is controlled by a controller (not shown) which creates drive signals that turn on or off each of the individually controllable grating regions 526. For the case of electrically switched gratings, these signals are electronic and may be applied to the individual grating segments by lithographically patterning a transparent conductor such as Indium Tin Oxide (ITO).

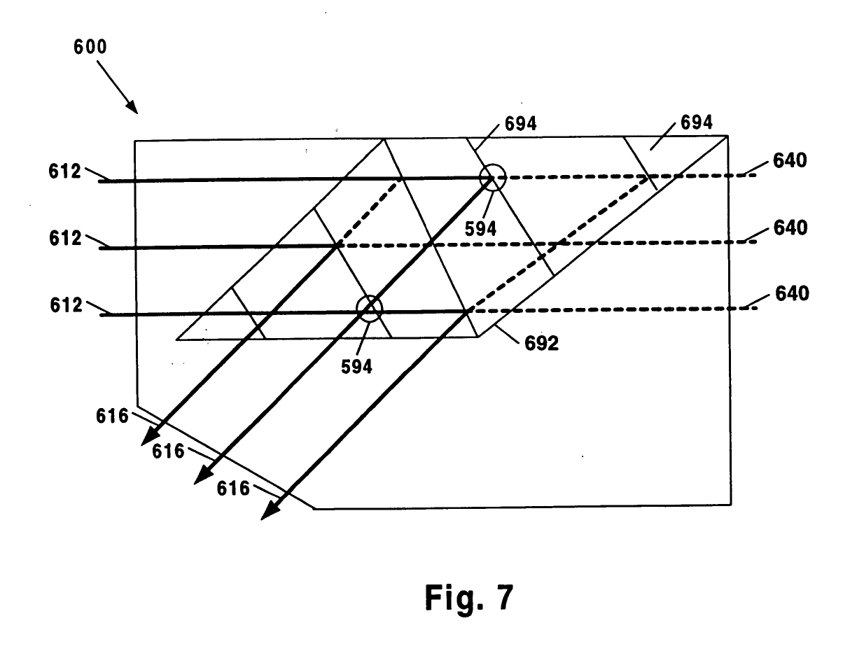

The switchable mirror embodiment 600 of the planar switch, also disclosed in U.S. patent application Ser. No. 09/943,847 and shown in FIG. 7, would not introduce residual angular or lateral dispersion from the switch. The planar switch 600 makes use of an array 692 of switchable reflection gratings 694 (also referred to as switchable mirrors). The switchable reflection gratings 694 may be, for example, volume holographic diffraction gratings or other switched mirror technology. The switch 600 of FIG. 7 would be a single layer of a stack, shown in cross-section from above. Although three input channels 612 and three output channels 616 are shown, it should be noted that embodiments with other numbers of input and output channels are possible. “Through” or undiffracted output ports 640 may also be useful for some applications.

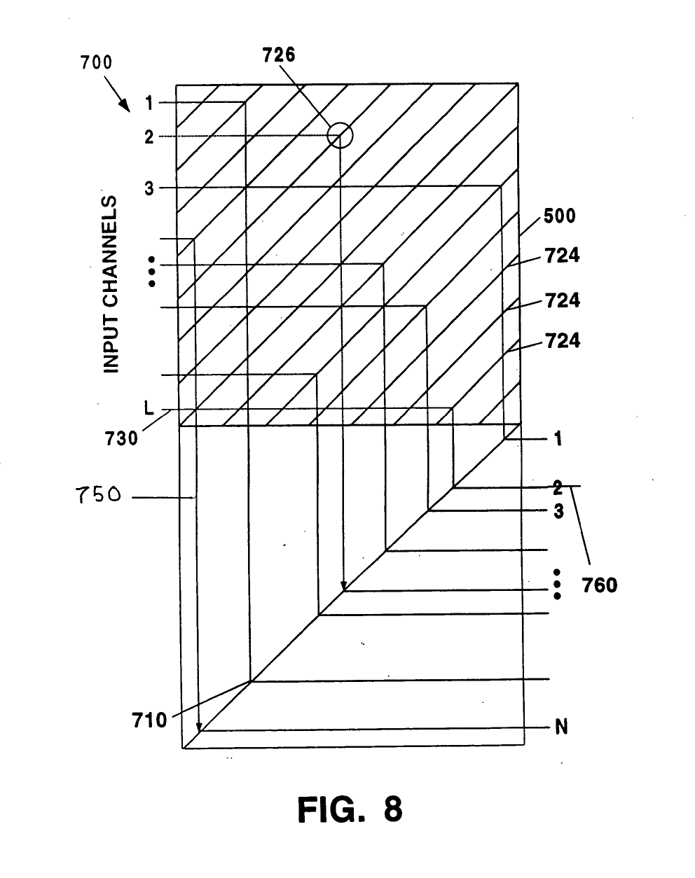

Similarly the transmission switch array 700 of FIG. 8 could be used, and would result in an offset. Referring to FIG. 8, transmission switch array 700 includes the planar switch array 500 of FIG. 6a and grating 710. The advantage of the switch of FIG. 8 is that it is wavelength compensated for angular dispersion even with transmission gratings, although there is residual lateral dispersion.

As further illustrated in FIG. 8, any of the input ports can be directly coupled to any of the output ports by switching on the appropriate grating region 726. An example of the operation of the system 700 is shown in FIG. 8 by connecting the Lth input channel 730 to the second output channel 760. The regions or pixels of the first six diffractive gratings 724 that are encountered by beam 730 are switched “off”, and the optical input channel 730 is transmitted through them. The pixel encountered by this channel (beam) on the seventh diffractive grating 724, however, is switched “on”, and it diffracts the incident beam downward toward the grating 710. The diffracted beam 730 is redirected, by the grating 710, towards the desired (second) output channel location 760.

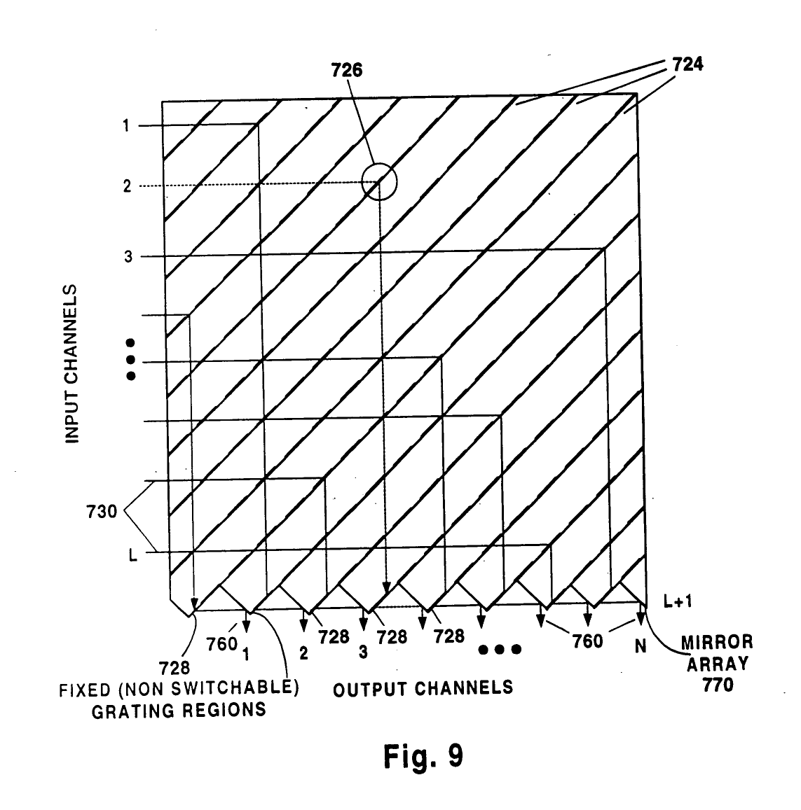

The lateral dispersion of the switch array of FIG. 8 is readily reduced by replacing the single large final compensation grating 710 with the non switchable extension of the lower edge of grating array formed by gratings 724 to an L+1 level, and using a mirror array 770 to redirect the compensated beams downward again, as shown in FIG. 9. The outputs from the system shown in FIG. 9 exhibit no angular chromatic dispersion, and roughly half of the lateral chromatic beam shifts than from the system of FIG. 8.

It should be noted that the input and output arrays of channels may consist of spectrally separated channels and/or spatially separated channels. In one embodiment, one or more input fibers could be used which could contain one or more spectrally separated channels.

It should also be noted that the input port (such as input port 20 in FIGS. 1a and 1b) could be optically modified (that is, contain further optical components) in order to achieve desired behavior at the separating system, such as, but not limited to, higher number of channels, improved coupling efficiency or more compact geometries.

It should be further noted that although Embodiments of separating and recombining subsystems were herein above described as including fixed gratings, switchable gratings could also be used in order to obtain benefits such as, but not limited to, enhanced switching system isolation and/or enhanced crosstalk suppression.

In many applications it is not desirable to couple an input channel into more than one output port. However, if is desired to couple an input channel into more than one output port, this could be accomplished utilizing the tunable diffraction efficiency (or fan out/fan in) capability of some of the diffractive switching/routing elements described above.

While the system of this invention is described hereinabove as mapping the input channels into distinct output channels, it should be noted that the distinct output channels can include the null set, as in the case of a switching/routing operating as a filter.

Although the invention has been described with reference to particular embodiments, it will be understood that this invention is also capable of further and other embodiments within the spirit and scope of the appended claims.

1. A method for optically switching/routing comprising the steps of:
separating input optical radiation into distinct input channels;
selecting desired distinct output channels;
propagating said distinct input channels through a selectable grating based switching/routing sub-system in order to direct said distinct input channels to desired distinct output channels;
recombining said desired distinct output channels.

2. The method of claim 1 wherein the step of separating input optical radiation comprises the step of utilizing a separating sub-system comprising a pair of separating gratings; and,
wherein the step of recombining said desired distinct output channels comprises the step of utilizing a recombining sub-system comprising a pair of recombining gratings.

3. The method of claim 1 wherein the step of separating input optical radiation comprises the step of utilizing a separating sub-system comprising at least one Array Waveguide Grating (AWG); and,
wherein the step of recombining said desired distinct output channels comprises the step of utilizing a recombining sub-sytem comprising at least one Array Waveguide Grating.

4. The method of claim 1 wherein the grating based switching/routing sub-system comprises a volume holographic grating based switching/routing sub-system.

5. An optical switching/routing system comprising:
an optical separating sub-system;
said optical separating sub-system being capable of separating input optical radiation from at least one input beam/port into distinct input channels;
an optical recombining sub-system;
a selectable free space grating based switching/routing sub-system, said selectable switching and routing sub-sytem being interposed optically between said optical separating sub-system and said optical recombining sub-sytem; and;
said selectable switching/routing sub-system being capable of switching/routing said distinct input channels to desired distinct output channels;
said optical recombining subsystem being capable of redirecting and recombining said desired distinct output channels for output into at least one output beam/port.

6. The optical system of claim 5 wherein said selectable switching/routing sub-system includes at least one pixellated switchable component.

7. The optical system of claim 5 wherein said optical separating sub-system comprises a first separating diffraction grating, and a second separating diffraction grating; and,
wherein said optical recombining sub-system comprises a first recombining diffraction grating, and a second recombining diffraction grating.

8. The optical system of claim 7 wherein at least one of said first separating diffraction grating, said second separating diffraction grating, said first recombining diffraction grating, and said second recombining diffraction grating comprises a fixed grating.

9. The optical system of claim 7 wherein at least one of said first separating diffraction grating, said second separating diffraction grating, said first recombining diffraction grating, and said second recombining diffraction grating comprises a volume holographic grating.

10. The optical system of claim 7 wherein said first separating diffraction grating is substantially parallel to said second separating diffraction grating, and, said first recombining diffraction grating is substantially parallel to said second recombining diffraction grating.

11. The optical system of claim 4 wherein said selectable switching/routing sub-system comprises a switchable grating based sub-system.

12. The optical system of claim 9 wherein said switchable grating based sub-system comprises a planar switchable grating based sub-system.

13. The optical system of claim 4 wherein said selectable switching and routing sub-system comprises a switchable mirror based sub-system.

14. The optical system of claim 11 wherein said selectable switching and routing sub-system comprises a planar switchable mirror based sub-system.

15. The optical system of claim 4 wherein said optical separating sub-system comprises an Array Waveguide Grating (AWG); and,
wherein the optical recombining sub-system comprises an Array Waveguide Grating.

16. The optical system of claim 13 further comprising at least one microlens array.

17. The optical system of claim 13 further comprising anamorphic optics for circularizing the waveguide outputs of the separating AWG.

18. The optical system of claim 4 further comprising:
means operably connected to said selectable switching and routing sub-system for controlling the state of each pixels from a plurality of pixels;
said controlling means being capable of enabling the selecting of desired distinct output channels.

19. An optical switching/routing sub-system comprising:
first diffractive grating means for receiving and directing each of a plurality of input beams of electromagnetic radiation to travel in free space along a predetermined path of a plurality of separate paths to a predetermined output location of a plurality of output locations; and
second diffractive grating means;
said first diffractive grating means comprising a plurality of substantially evenly spaced apart switchable transmissive diffractive gratings and each of said spaced apart switchable transmissive diffractive gratings having at least one separately switchable region; and
said at least one said separately switchable region of said switchable diffractive gratings capable of being selectively activated or deactivated in order to independently control which said predetermined path of said plurality of separate paths at least one of said plurality of input beams of electromagnetic radiation travels in free space;
said second diffractive grating means receiving a plurality of output beams from said plurality of output locations and redirecting said output beams, said plurality of redirected output beams being substantially parallel to said plurality of input beams.

20. The optical switching and routing sub-system of claim 19 wherein said second diffractive grating means comprises a fixed grating.

21. The optical switching and routing sub-system of claim 19 further comprising a reflector array;
a location of said second diffractive grating means being substantially coincident with extensions of substantially evenly spaced apart switchable transmissive diffractive gratings; and
wherein said reflector array further redirects said plurality of output beams ensuring that said plurality of output beams remain separated.
